(19) United States
(12) Patent Application Publication
(10) Pub. No.: US 2008/0080033 A1
(43) Pub. Date: Apr. 3, 2008

(54) DISPLAY APPARATUS HAVING LIGHT MODULATOR AND METHOD FOR SETTING SCANNING PROFILE

(75) Inventor: Kyu-Bum Han, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/864,497

(22) Filed: Sep. 28, 2007

(30) Foreign Application Priority Data
Oct. 2, 2006 (KR) 1020060097344

(51) Int. Cl. G02B 26/10

(52) U.S. Cl. 359/223

(57) ABSTRACT

Disclosed is a display apparatus comprising: a light modulator; a scanning device configured to scan modulated light from the light modulator on a screen in two directions; a scanner driver configured to supply the scanning device with power and control a position of the scanning device; a memory configured to store a scanning profile, the scanning profile enabling the scanner driver to control a position of the scanning device; a projection control part configured to control an image projection of the light modulator by providing the scanner driver with a scanner control signal corresponding to the scanning profile read from the memory, wherein the scanning profile is configured to divide a scanning area scanned by the scanning device into an effective image area and a scan direction change area, and to apply a separate profile function to each of the effective image area and the scan direction change area.

### CROSS-REFERENCE TO RELATED APPLICATIONS

This application claims the benefit of Korean Patent Application No. 10-2006-0097344 filed with the Korean Intellectual Property Office on Oct. 2, 2006, the disclosure of which is incorporated herein by reference in their entirety.

### BACKGROUND

1. Technical Field

The present invention relates to a display apparatus using a light modulator, more particularly to a display apparatus that generates a two dimensional image by scanning one dimensional laser beams modulated by a light modulator, and has a scanning profile of which scanning area is divided to apply separate functions.

2. Description of the Related Art

With the introduction of optical signal processing, it became easier to process large amount of data fast and parallel. Also, optical modulation has been applied to bi-phase filters, optical logic gates, optical amplifiers, optical elements and light modulators. Especially, the light modulator is being used in fields such as optical memories, optical displays, printers, optical interconnections, holograms, optical scanners, etc.

Such an optical scanner is employed in an image forming apparatus, for example, laser printers, LED printers, electronic photocopiers, word processors, projectors, etc.

Recently, as projection televisions have been developed, the optical scanner is also used in the projection TV to project beams to a screen.

FIG. 1 is a diagram of a display apparatus using a light modulator and a scanning device. In FIG. 1 are illustrated a light source 10 having a light modulator, a controller part 20, a lens 30, a scanning device 40 and a screen 50. Unless otherwise described, the display apparatus in the present invention includes a light modulator.

The light source 10 includes a light modulator, and emits laser beams reflected and diffracted by the light modulator. The light source 10 emits linear laser beams in a longitudinal direction of the screen. These laser beams create a two dimensional image through the scanning device 40 rotating in lateral directions about a rotation axis.

The controller part 20 controls the light source 10 and the scanning device 40 to be turned on or off. The lens 30 concentrates laser beams from the light source 10 to the scanning device 40.

The scanning device 40 is controlled by the controller part 20 to be turned on or off, and when turned on, rotates about its axis. Here, it is assumed that the scanning device 40 is a galvano mirror.

The scanning device 40 has a motor (not shown) that allows the scanning device 40 to rotate in two directions, and reflects the beams from the lens 30 to the screen 50.

FIG. 2A illustrates laser beams projected to the screen by the scanning device, and FIG. 2B shows a scanning profile for controlling the operation of the scanning device.

Referring to FIG. 2a, the scanning device 40 rotates in two directions, from position A to position B and from position B to position A, so that a one dimensional image from the light modulator is scanned laterally on the screen, generating a two dimensional image

In order to control the rotation of the scanning device 40, a scanning profile is stored in advance in a memory (not shown). The scanning profile contains position values of the scanning device 40, and provides the position values to a scanner driver (not shown), so that the scanning device 40 can rotate in accordance with the position values.

The position value contained in the scanning profile is in a digital form, and the scanner driver converts the position value to have an analog form, and then provides the analog value to the scanning device 40. The scanner driver has a sensor sensing its own position and a feedback circuit, and controls the scanning device 40 to rotate in accordance with the position value of the scanning profile.

FIG. 2b illustrates an example of conventional scanning profile. A position profile of the scanning profile has a form of a chopping wave, and allows the scanning device 40 to rotate between positions A and B in two directions. Here, it is assumed that with one scanning, an image in one of red, green or blue color is generated, and with three repetitive scannings, a full color image with red, green and blue colors is generated.

Suppose that with a first scanning, a red image is projected, and the scanning device 40 rotates from position A to position B. The first scanning follows a first position function 60(1) that is a linear function, and a first velocity function 70(1) that is a constant function. Subsequently, the scanning device 40 rotates from the position B to the position A projecting a green image. This second scanning follows a second position function 60(2) that is a linear function, and a second velocity function that is another constant function. Here, the constant of the second velocity function has the opposite sign to that of the first velocity function.

The scanning device 40 reverses its direction during a blank time during which no effective image is outputted, causing an abrupt change in the direction of velocity vector (refer to 80(1) in FIG. 2b).

Such an abrupt change increases power consumption, which is disadvantageous to portable devices such as mobile phones, PDAs, notebook computers, etc. that are demanded to reduce power consumption, especially when the portable device is furnished with projector function.

### SUMMARY

Accordingly, the present invention provides a display apparatus and a scanning profile setting method that can reduce power consumption and a load applied to a scanner driver in a section where a change in the direction of scanning velocity vector occurs by decreasing scanning velocity change rate.

Also, the present invention provides a mobile display apparatus applicable to a portable device.

The invention provides a display apparatus comprising: a light modulator; a scanning device configured to scan modulated light from the light modulator on a screen in two directions; a scanner driver configured to supply the scanning device with power and control a position of the scanning device; a memory configured to store a scanning profile, the scanning profile enabling the scanner driver to control a position of the scanning device; a projection control part configured to control an image projection of the light modulator by providing the scanner driver with a scanner control signal corresponding to the scanning profile read from the memory, wherein the scanning profile is configured to divide a scanning area scanned by the scanning device into an effective image area and a scan direction change area, and to apply a separate profile function to each of the effective image area and the scan direction change area.

The scanning profile is a position profile, and a linear function is applied to the effective image area and a quadratic or higher order function is applied to the scan direction change area.

The scanning profile is a velocity profile, and a constant function is applied to the effective image area and a linear function is applied to the scan direction change area.

Here, the velocity profile applies to the scan direction change area a linear function with a slope equal to or less than a predetermined slope.

The scanning profile is an acceleration profile, zero acceleration is applied to the effective image area, and a finite acceleration equal to or less than a predetermined acceleration is applied to the scan direction change area.

Here, the scanning device has a form of a galvano mirror.

Also, the light modulator comprises: a plurality of micro-mirrors reflecting incident light; and a driving element configured to drive the micro-mirror upward and downward with an applied voltage, wherein one micro-mirror is responsible for one pixel in a picture, and the projection control part is configured to supply to the driving means a voltage corresponding to image information.

Another aspect of the invention provides a method for setting a scanning profile that controls a scanning device rotating in two directions, the method comprising: distinguishing an effective image area and a scan direction change area in a scanning area; and applying a separate profile function to each of the effective image area and the scan direction change area.

The scanning profile is a position profile, and the applying comprises applying a linear function to the effective image area and a function of second order or higher to the scan direction change area.

The scanning profile is a velocity profile, and the applying comprises applying a constant function to the effective image area and a linear function to the scan direction change area.

Here, the velocity profile applies to the scan direction change area a linear function with a slope equal to or less than a predetermined slope.

The scanning profile is an acceleration profile, and the applying comprises applying zero acceleration to the effective image area and a finite acceleration equal to or less than a predetermined acceleration to the scan direction change area.

Additional aspects and advantages of the present general inventive concept will be set forth in part in the description which follows, and in part will be obvious from the description, or may be learned by practice of the general inventive concept.

### BRIEF DESCRIPTION OF THE DRAWINGS

These and other features, aspects, and advantages of the present invention will become better understood with regard to the following description, appended claims, and accompanying drawings where:

FIG. 1 is a diagram of a display apparatus using a light modulator and a scanning device;

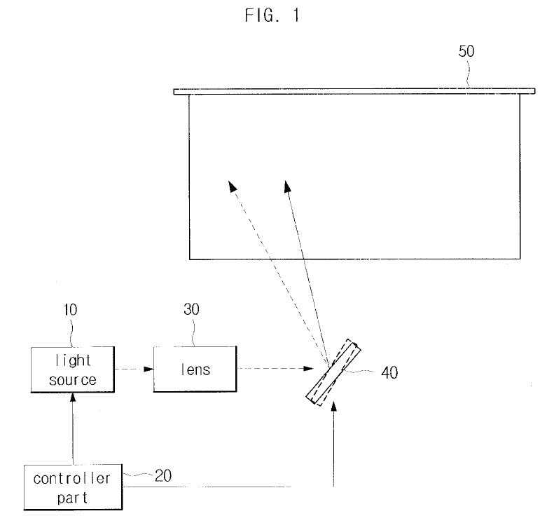

FIG. 2A illustrates laser beams projected to the screen by a scanning device;

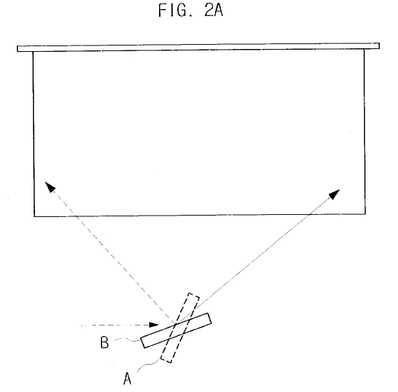

FIG. 2B shows a scanning profile for controlling the operation of the scanning device;

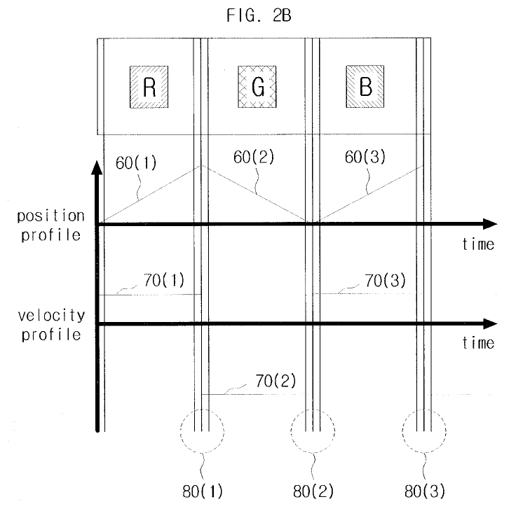

FIG. 3A is a perspective view of a diffraction type light modulator module using piezoelectric elements, applicable to an embodiment of the invention;

FIG. 3B is a perspective view of another diffraction type light modulator module using piezoelectric elements, applicable to an embodiment of the invention;

FIG. 3C is a plan view of a diffraction type light modulator array applicable to an embodiment of the present invention;.

FIG. 3D is a schematic diagram illustrating an image generated on a screen by means of a diffraction type light modulator array applicable to an embodiment of the invention.

FIG. 4 illustrates the organization of a portable device according to an embodiment of the present invention.

FIG. 5 is a block diagram of a display apparatus controller of the projection part 480;

FIG. 6 is a timing graph for generating a scanning profile according to an embodiment of the present invention

FIG. 7 illustrates an area where scanning is performed by a scanning device.

FIG. 8 is a graph showing position input level and timing for each section of a scanning profile.

FIG. 9 illustrates an area on a screen scanned by a scanning device.

FIG. 10 compares a scanning profile according to a prior art with a scanning profile created according to an embodiment of the present invention.

### DETAILED DESCRIPTION

Hereinafter, embodiments of the invention will be described in more detail with reference to the accompanying drawings. In the description with reference to the accompanying drawings, those components are rendered the same reference number that are the same or are in correspondence regardless of the figure number, and redundant explanations are omitted.

The optical modulator can be divided mainly into a direct type, which directly controls the on/off state of light, and an indirect type, which uses reflection and diffraction. The indirect type may be further divided into an electrostatic type and a piezoelectric type. Optical modulators are applicable to the embodiments of the invention regardless of the operation type.

An electrostatic type grating optical modulator as disclosed in U.S. Pat. No. 5,311,360 includes a plurality of equally spaced-apart deformable reflective ribbons having reflective surfaces and suspended above the upper part of the substrate.

First, an insulation layer is deposited onto a silicon substrate, followed by the deposition of a sacrificial silicon dioxide film and a silicon nitride film. The silicon nitride film is patterned from the ribbons, and portions of the silicon dioxide film are etched so that the ribbons are maintained by the nitride frame on the oxide spacer layer.

The grating amplitude, of such a modulator limited to the vertical distance d between the reflective surfaces of the ribbons and the reflective surface of the substrate, is controlled by supplying voltage between the ribbons (the reflective surface of the ribbon, which acts as the first electrode) and the substrate (the conductive film at the bottom portion of the substrate, which acts as the second electrode).

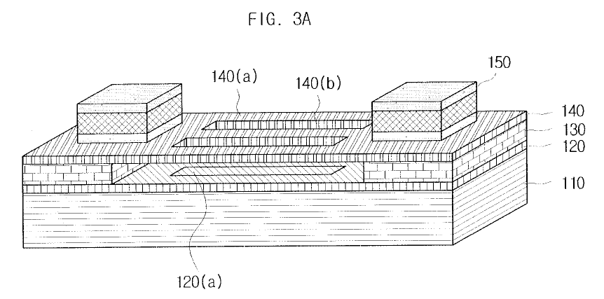

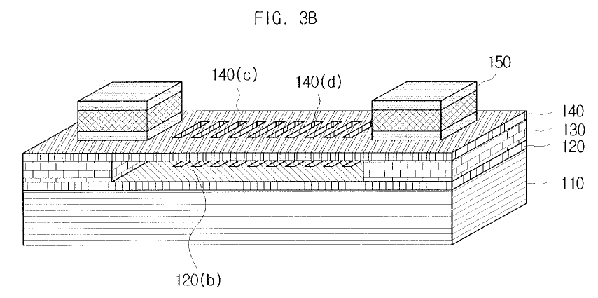

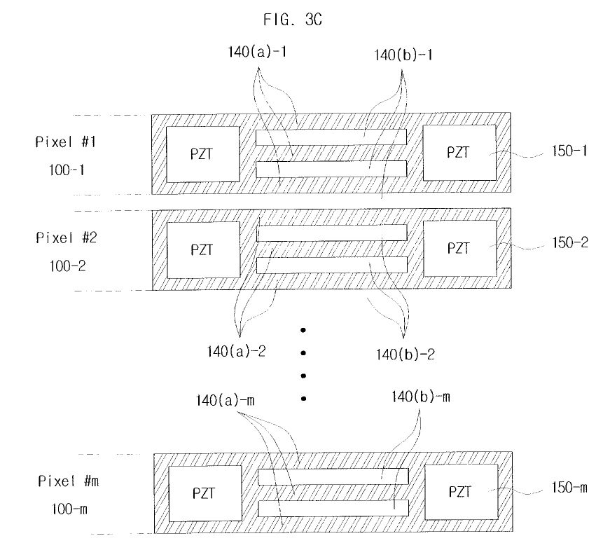

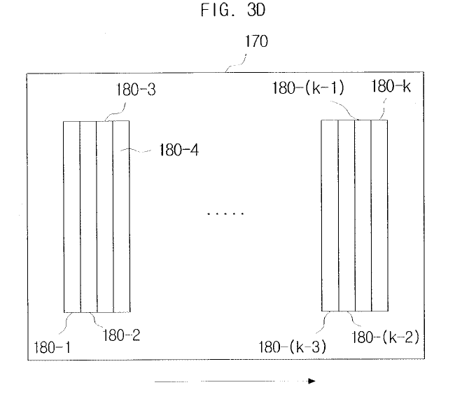

FIG. 3A is a perspective view of a micro-mirror included in a light modulator using piezoelectric elements, applicable to an embodiment of the invention, and FIG. 3B is a perspective view of another micro-mirror included in a light modulator using piezoelectric elements, applicable to an embodiment of the invention. In FIGS. 3a and 3b are illustrated micro-mirrors, each including a substrate 110, an insulation layer 120, a sacrificial layer 130, a ribbon structure 140, and piezoelectric elements 150.

The substrate 110 is a commonly used semiconductor substrate, and the insulation layer 120 is deposited as an etch stop layer. The insulation layer 120 is formed from a material with a high selectivity to the etchant (the etchant is an etchant gas or an etchant solution) that etches the material used as the sacrificial layer. Here, reflective layers 120(a), 120(b) may be formed on the insulation layer 120 to reflect incident beams of light.

The sacrificial layer 130 supports the ribbon structure 140 such that the ribbon structure is spaced by a particular gap from the insulation layer 120, and forms a space in the center.

The ribbon structure 140 creates diffraction and interference in the incident light to provide optical modulation of signals as described above. The form of the ribbon structure 140 may be composed of a plurality of ribbon shapes according to the electrostatic type, and may comprise a plurality of open holes 140(b), 140(d) in the center portion of the ribbons according to the piezoelectric type. The piezoelectric elements 150 control the ribbon structure 140 to move vertically, according to the degree of up/down or left/right contraction and expansion generated by the difference in voltage between the upper and lower electrodes. Here, the reflective layers 120(a), 120(b) are formed in correspondence with the holes 140(b), 140(d) formed in the ribbon structure 140.

For example, in the case where the wavelength of a beam of light is λ, when there is no power supplied or when there is a predetermined amount of power supplied, the gap between an upper reflective layer 140(a), 140(c) formed on the ribbon structure and the insulation layer 120, on which is formed a lower reflective layer 120(a), 120(b), is equal to nλ/2 (wherein n is a natural number). Therefore, in the case of a 0-order diffracted (reflected) beam of light, the overall path length difference between the light reflected by the upper reflective layer 140(a), 140(c) formed on the ribbon structure and the light reflected by the insulation layer 120 is equal to nλ, so that constructive interference occurs and the diffracted light is rendered its maximum luminosity. In the case of +1st or −1st order diffracted light, however, the luminosity of the light is at its minimum value due to a destructive interference.

Also, when an appropriate amount of power is supplied to the piezoelectric elements 150, other than the supplied power mentioned above, the gap between the upper reflective layer 140(a), 140(c) formed on the ribbon structure and the insulation layer 120, on which is formed the lower reflective layer 120(a), 120(b), becomes (2n+1)λ/4 (wherein n is a natural number). Therefore, in the case of a 0-order diffracted (reflected) beam of light, the overall path length difference between the light reflected by the upper reflective layer 140(a), 140(c) formed on the ribbon structure and the light reflected by the insulation layer 120 is equal to (2n+1)λ/2, so that destructive interference occurs, and the diffracted light is rendered its minimum luminosity. In the case of +1 or −1 order diffracted light, however, the luminosity of the light is at its maximum value due to constructive interference. As a result of such interference, the optical modulator can load signals on the beams of light by controlling the quantity of the reflected or diffracted light.

While the foregoing describes the cases in which the gap between the ribbon structure 140 and the insulation layer 225, on which is formed the lower reflective layer 120(a), 120(b), is nλ/2 or (2n+1)λ/4, it is obvious that a variety of embodiments may be applied with regards the present invention which are operated with gaps that allow the control of the interference by diffraction and reflection.

The descriptions below will focus on the type of optical modulator illustrated in FIG. 3A described above. Also, 0-order diffracted (reflected) light, +n-order diffracted light, −n order diffracted light (n is a natural number) is collectively referred to as modulated light.

FIG. 3C is a plan view of a light modulator having a plurality of micro mirrors as shown in FIG. 3A.

Referring to FIG. 3C, the optical modulator is composed of an m number of micromirrors 100-1, 100-2, . . . , 100-m, each responsible for pixel #1, pixel #2, . . . , pixel #m. The optical modulator deals with image information with respect to 1-dimensional images of vertical or horizontal scanning lines (Here, it is assumed that a vertical or horizontal scanning line consists of an m number of pixels.), while each micromirror 100-1, 100-2, . . . , 100-m deals with one pixel among the m pixels constituting the vertical or horizontal scanning line. Thus, the light reflected and diffracted by each micromirror is later projected by an optical scanning device as a 2-dimensional image on a screen. For example, in the case of VGA 640*480 resolution, modulation is performed 640 times on one surface of an optical scanning device (not shown) for 480 vertical pixels, to generate 1 frame of display per surface of the optical scanning device. Here, the optical scanning device may be a polygon mirror, a rotating bar, or a galvano mirror, etc.

While the description below of the principle of optical modulation concentrates on pixel #1, the same may obviously apply to other pixels.

In the present embodiment, it is assumed that the number of holes 140(b)-1 formed in the ribbon structure 140 is two. Because of the two holes 245(b)-1, there are three upper reflective layers 140(a)-1 formed on the upper portion of the ribbon structure 140. On the insulation layer 120, two lower reflective layers are formed in correspondence with the two holes 140(b)-1. Also, there is another lower reflective layer formed on the insulation layer 120 in correspondence with the gap between pixel #1 and pixel #2. Thus, there are an equal number of upper reflective layers 140(a)-1 and lower reflective layers per pixel, and as discussed with reference to FIG. 3A, it is possible to control the luminosity of the modulated light using 0-order diffracted light or ±1-order diffracted light.

FIG. 3D is a schematic diagram illustrating an image generated on a screen by means of a diffraction type optical modulator array applicable to an embodiment of the invention.

Illustrated is a display 180-1, 180-2, 180-3, 180-4, . . . , 180-(k-3), 180-(k-2), 180-(k-1), 180-k) generated when beams of light reflected and diffracted by an m number of vertically arranged micromirrors 100-1, 100-2, . . . , 100-k are reflected by the optical scanning device and scanned horizontally onto a screen 170. One image frame may be projected with one revolution of the optical scanning device. Here, although the scanning direction is illustrated as being from left to right (the direction of the arrow), it is apparent that images may be scanned in other directions (e.g. in the opposite direction).

The present invention is applicable to a display apparatus having a one dimensional diffraction type light modulator as described above. Also, the present invention can be applied to a portable device having projector function (for example, mobile phones, PDAs, notebook computers, etc.) in order to reduce power consumption in the portable device.

The following description describes the invention focusing on a portable device having projector function. However, it shall not be interpreted as limiting the scope of the invention.

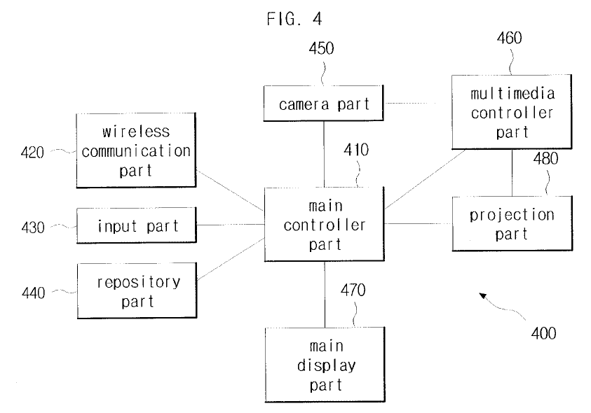

FIG. 4 illustrates the organization of a portable device according to an embodiment of the present invention. Referring to FIG. 4, the portable device 400 includes a main controller part 410, a wireless communication part 420, an input part 430, a repository part 440, a camera part 450, a multimedia controller part 460, a main display part 470 and a projection part 480.

The main controller part 410 controls the overall operation of the portable device 400. For example, the main controller part 410 may control the camera part 450 in accordance with a signal transmitted from the input part 430, which generates signals corresponding to a user's choice.

The main controller part 410 activates the projection part 480, and transmits image data (for example, JPEG, BMP, etc.) and video data (MPEG, AVI, etc.) to the projection part 480. Here, a signal for activating the projection part 480 (hereinafter, referred to as ‘projection part activating order’) is generated by the input part 430 according to a user's manipulation.

Also, the image data may be stored in the repository part 440, or may be transmitted directly from the camera part 450 to the main controller part 410 (in the latter case, the image data may be raw data that is not encoded).

For instance, if a signal for outputting particular image data (this signal may be generated in the input part 430 according to a user's manipulation. hereinafter, referred to as ‘image data output order’) stored in the repository part 440 is transmitted under the condition that the projection part 480 is activated, the main controller part 410 reads corresponding image data from the repository part 440 and transmits it to the projection part 480.

The main controller part 410 may transmit the same image data to the main display part 470 as well at the same time. In such a case, the main controller part 410 may generate an image data display order and transmit it together with image data or separately. The image data display order may include a projection part activating order and image data information on a frame forming a picture.

Here, the image data information may contain information on light intensity of pixels in the amount of (the number of pixels of vertical scanning line)×(the number of pixels of horizontal scanning line), and image data to be outputted.

The main controller part 410 may correct image data before the image data is transmitted to the main display part 470 and/or the projection part 480. For example, the main controller part 410 may correct the size, the color, the pixel and/or the resolution of the image data in accordance with a signal for correcting to-be-outputted image data (hereinafter, referred to as “an image correction order”), and then transmit the corrected image data to the projection part 480. Here, the image correction order may be generated in the input part 430 based on a user's manipulation.

In the case that the portable device 400 does not have a separate multimedia controller part 460, the main controller part 410 may also function as a multimedia controller part. For instance, the main controller part 410 may control the camera part 450.

The wireless communication part 420 enables the portable device 400 to perform wireless communication services. For example, under the condition that a wireless communication mode is operating, the wireless communication part 420 may decode inputted voice and/or image signals (video data, photo data, text data, etc.) in a predetermined way and then transmit them to the main controller part 410, or the wireless communication part 420 may encode voice and/or image signals inputted through the main controller part 410 in a predetermined way and then transmit to the outside.

The input part 430 generates signals based on a user's manipulation and transmits them to the main controller part 410. In particular, the input part 430 generates the projection part activating order, the image data output order and/or the image correction order, and transmits them to the main controller part 410. The input part 430 may be formed of a key pad and/or a touch pad.

The repository part 440 may store a variety of data used in the portable device 400, especially image data. More specifically, raw image data inputted through the camera part 450 is encoded in the main controller part 410 and/or the multimedia controller part 460 and then stored in the repository part 440. The stored image data may be read by the main controller part 410.

The camera part 450 converts image signals inputted from the outside into electrical signals, thereby generating raw image data, which is then transmitted to the main controller part 410 and/or the multimedia controller part 460. Here, the main controller part 410 may allow the transmitted raw image data to be displayed through the main display part 470 or the projection part 480.

The multimedia controller part 460 controls a variety of multimedia functions (such as reproducing MP3 files, photographing, etc.) of the portable device 400. For example, the multimedia controller part 460 may decode inputted image data, or encode raw image data. However, the portable device 400 can also be configured such that the main controller part 410 serves as a multimedia controller part.

The main display part 470 exhibits output of a variety of functions of the portable device 400. For example, image data may be processed in the main controller part 410 in accordance with an image data output order to be outputted to the outside through the main display part 470. The main display part 470 may be formed of an LCD.

The projection part 480 also exhibits output of a variety of functions of the portable device 400. A user has an option of operating the projection part 480 singly or together with the main display part 470.

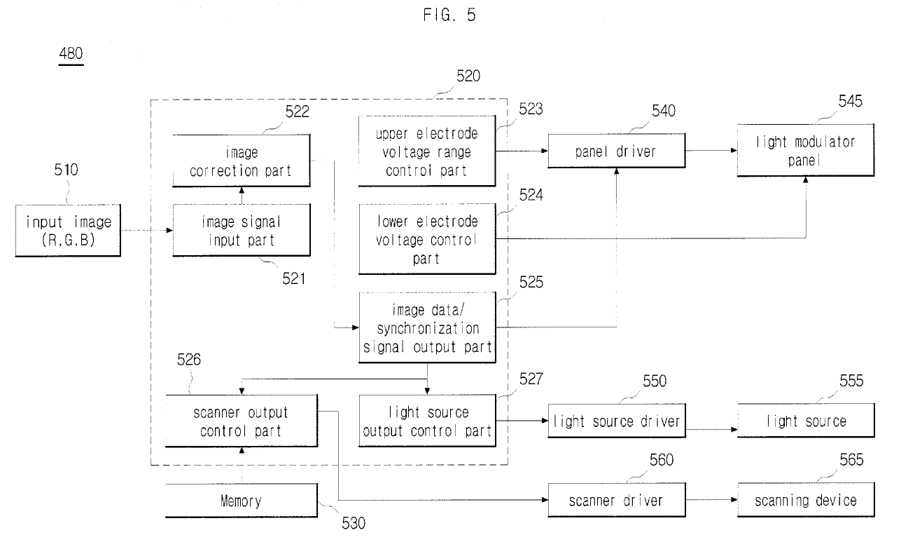

FIG. 5 is a block diagram of a display apparatus controller of the projection part 480. Referring to FIG. 5, image signals consisting of R, G, and B are inputted to the display apparatus controller 520. Here, an image signal input part 521 delivers to an image correction part 522 an image signal composed of R, G, and B digital data and a timing signal. The image correction part 522 corrects the received image signal according to a deviation between elements. The image correction part 522 is connected with an outside memory 530, so that it reads initial setting value and performs a correction process according to a correction logic.

An image data synchronization signal output part 525 changes the order of data inputted in row by row order such that the data is outputted in column by column order, and delivers a synchronization signal per frame, a pixel synchronization signal and a vertical line output timing signal, etc. to a panel driver 540.

The panel driver 540 converts digital image data to analog signals for operating panels, and operates a light modulator panel 545 in synchronization with the vertical line output timing signal. Also, the panel driver 540 matches the gradation of image to an output voltage level by referring to an analog voltage range determined in an upper electrode voltage range control part 523

The light modulator panel 545 deforms itself due to a voltage difference between an upper electrode and a lower electrode (to which voltage is supplied by a lower electrode voltage control part 524), thereby adjusting the intensity of incident light from a light source 555.

A scanner output control part 526 outputs a position control signal of a scanning device 565 to a scanner driver 560 in synchronization with the vertical line output timing signal. A light source output control part 527 generates a light source control signal that controls the light source 555 to output R, G, B lights sequentially in synchronization with the image synchronization signal, and transmits the light source control signal to a light source driver 550 driving the light source 555. A memory 530 stores correction values (per pixel, per color) for the image correction part 522, a voltage range for the upper electrode, an initial setting value for the lower electrode, a scanning profile and an output setting value for the light source.

The scanner output control part 526 reads a position value as a digital value from the scanning profile stored in the memory 530, and outputs the value to the scanner driver 560, which converts the inputted digital value to an analog value, and provides the analog value to the scanning device 565, thereby controlling the position of the scanning device 565.

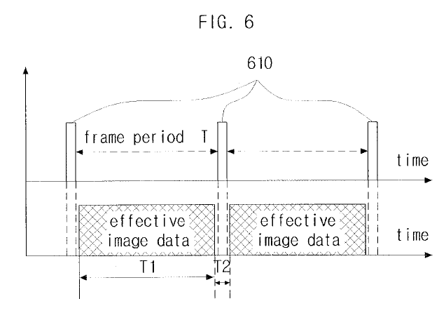

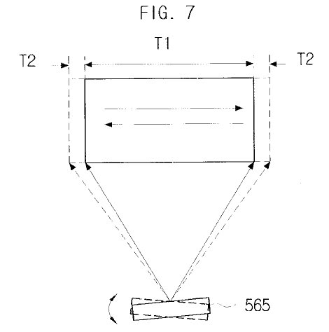

The scanning device 565 rotates in two directions about its rotation axis, and may be a galvano mirror that can scan image data in two directions. FIG. 6 is a timing graph for generating a scanning profile according to an embodiment of the present invention. FIG. 7 illustrates an area where scanning is performed by a scanning device.

Referring to FIG. 6, there is a blank time T2, during which no effective image data is outputted, while a scanning device performs scanning.

Suppose that a frame period is T. When the frame synchronization signal 610 is generated, a new image frame begins so that effective image data is outputted. The frame period is obtained by summing up the time T1 during which the effective image data is outputted and the time T2 during which no effective data image is outputted.

Referring to FIG. 7, the scanning device 565 allows effective image data to be displayed on the screen during the time T1. Also, the scanning device reverses scan direction during the blank time to scan a one dimensional image for a next frame in an opposite direction, so that a two dimensional image can be displayed on the screen.

Here, during the time T1, the scanning device 565 may change its position at linear rate about the rotation axis in order to project image data uniformly on the screen, thereby reduce image distortion.

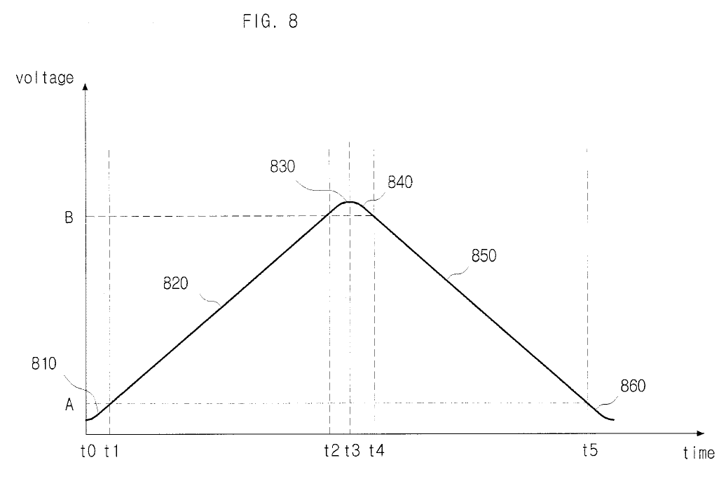

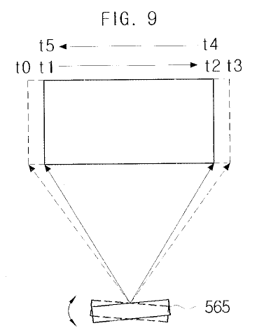

A method for setting a scanning profile according to the present invention will be described with reference to FIGS. 8 and 9.

FIG. 8 is a graph showing position input level and timing for each section of a scanning profile. FIG. 9 illustrates an area on a screen scanned by a scanning device. The scanning profile may include a position profile, a velocity profile, an acceleration profile, etc. The description below focuses on the position profile.

Referring to FIG. 8, the points A and B indicate position values of the scanning device 565 corresponding to both ends of an effective picture displayed on the screen. The position value may be a voltage level, a current level, or the like.

The points t0 and t3 indicate points of time when the scanning device 565 changes scan direction (from a first direction to a second direction or from a second direction to a first direction). The point t1 indicates a point of time when an effective picture with the first scan direction begins, and the point t2 indicates a point of time when the effective picture with the first scan direction ends. The point t3 indicates a point of time when an effective picture with the second scan direction begins, and the point t4 indicates a point of time when the effective picture with the second scan direction ends. Here, the first direction is opposite to the second direction. Here, it is assumed that the first direction is a forward direction, and the second direction is a backward direction.

Referring to FIG. 9, at the point t0, the scan direction of the scanning device 565 is reversed from backward to forward. Effective image data begins outputting at the point t1, and finishes outputting at the point t2. At the point t3, the scan direction of the scanning device 565 is reversed from forward to backward. While the scanning device 565 rotates in the backward direction, effective image data is outputted on the screen during a time from the point t4 to the point t5.

Therefore, the scanning area can be divided into an effective image area where effective image data is outputted, and a scan direction change area where the scan direction of the scanning device 565 is reversed.

The effective image area includes a first scanning area 820 corresponding to a section ranging from the point t1 to the point t2, and a second scanning area 850 corresponding to a section ranging from the point t4 to the point t5.

The scanning profile (a position profile, in this description) corresponding to the effective image area is composed of a linear function. The linear function may be represented as follows:

Profile 1=Plin(t)=at+b [Function 1]

Boundary condition for the first scanning area 820 : Plin(t1)=A, Plin(t2)=B

Boundary condition for the second scanning area 850 : Plin(t4)=B, Plin(t5)=A

The scan direction change area includes a section from the point t0 to the point t1, a section from the point t2 to the point t3, and a section from the point t3 to the point t4, which are defined as a third scanning area 810, a fourth scanning area 830 and a fifth scanning area 840, respectively.

The scanning profile (a position profile, in this description) corresponding to the scan direction change area is composed of a quadratic function or a function of higher degree, the example of which is as follows:

Profile 2=Pble(t)=at²+bt+c

P′ble(t)=2at+b [Function 2]

Boundary condition for the third scanning area 810:

Pble(t1)=A,

P′ble(t0)=0,P′ble(t1)=P′lin(t1)

→the velocity at the point t0 is 0, and the velocity at the point t1 is the same in the first scanning area 820 and the third scanning area 810.

Boundary condition for the fourth scanning area 830:

Pble(t2)=B,

P′ble(t3)=0, P′ble(t2)=P′lin(t2)

→the velocity at the point t3 is 0, and the velocity at the point t2 is the same in the first scanning area 820 and the fourth scanning area 830.

Boundary condition for the fifth scanning area 840:

Pble(t4)=B,

P′ble(t3)=0, P′ble(t4)=P′lin(t4)

→the velocity at the point t3 is 0, and the velocity at the point t4 is the same in the second scanning area 850 and the fifth scanning area 840.

As described above, the position profile can be created by using a linear function for the effective image area and a high order function for the scan direction change area.

By using a high order function for the scan direction change area, the scanning device can reverse the scan direction without an abrupt change in velocity vector. Accordingly, the scanner driver receives fewer loads and consumes less power.

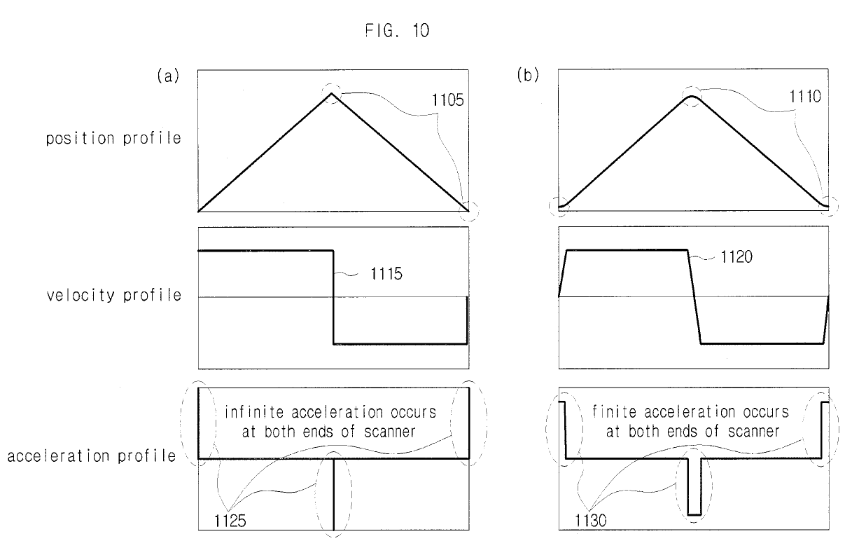

FIG. 10 compares a scanning profile according to a prior art with a scanning profile created according to an embodiment of the present invention.

FIG. 10(a) shows a position profile, a velocity profile and an acceleration profile according to the prior art. The conventional position profile has a form of a chopping wave (refer to Ref. No. 1105) so that the conventional velocity profile shows an abrupt change (refer to Ref. No. 1115) in the direction of the velocity vector. Accordingly, an infinite acceleration occurs when the scanning device reverses its direction (refer to Ref. No. 1125), imposing a large load on the scanner driver.

FIG. 10(b) shows a position profile, a velocity profile and an acceleration profile according to an embodiment of the present invention.

The position profile is divided into the effective image area and the scan direction change area in order to apply a separate function to each area. A linear function is applied to the effective image area and a quadratic or higher order function is applied to the scan direction change area, so that the position profile has a different form from the conventional position profile.

The velocity profile applies a constant function to the effective image area and a linear function with a slope equal to or smaller than a predetermined slope to the scan direction change area (refer to Ref. No. 1120). Accordingly, the velocity vector can change its direction at a rate of the slope, causing no abrupt change.

The acceleration profile is configured such that the acceleration is zero in the effective image area, and is the same with or lower than a predetermined value in the scan direction change area (refer to Ref. No. 1130). When the scanning device reverses its direction, a finite acceleration occurs, changing the velocity vector gradually, so that the scanner driver receives fewer loads.

While the invention has been described with reference to the disclosed embodiments, it is to be appreciated that those skilled in the art can change or modify the embodiments without departing from the scope and spirit of the invention or its equivalents as stated below in the claims.

What is claimed is:

1. A display apparatus comprising:
a light modulator;
a scanning device configured to scan modulated light from the light modulator on a screen in two directions;
a scanner driver configured to supply the scanning device with power and control a position of the scanning device;
a memory configured to store a scanning profile, the scanning profile enabling the scanner driver to control a position of the scanning device;
a projection control part configured to control an image projection of the light modulator by providing the scanner driver with a scanner control signal corresponding to the scanning profile read from the memory,
wherein the scanning profile is configured to divide a scanning area scanned by the scanning device into an effective image area and a scan direction change area, and to apply a separate profile function to each of the effective image area and the scan direction change area.

2. The display apparatus of claim 1, wherein the scanning profile is a position profile, and a linear function is applied to the effective image area and a quadratic or higher order function is applied to the scan direction change area.

3. The display apparatus of claim 1, wherein the scanning profile is a velocity profile, and a constant function is applied to the effective image area and a linear function is applied to the scan direction change area.

4. The display apparatus of claim 3, wherein the velocity profile applies to the scan direction change area a linear function with a slope equal to or less than a predetermined slope.

5. The display apparatus of claim 1, wherein the scanning profile is an acceleration profile, zero acceleration is applied to the effective image area, and a finite acceleration equal to or less than a predetermined acceleration is applied to the scan direction change area.

6. The display apparatus of claim 6, wherein the scanning device has a form of a galvano mirror.

7. The display apparatus of claim 1, wherein the light modulator comprises:
a plurality of micro-mirrors reflecting incident light; and
a driving element configured to drive the micro-mirror upward and downward with an applied voltage,
wherein one micro-mirror is responsible for one pixel in a picture, and the projection control part is configured to supply to the driving means a voltage corresponding to image information.

8. A method for setting a scanning profile that controls a scanning device rotating in two directions, the method comprising:
distinguishing an effective image area and a scan direction change area in a scanning area; and
applying a separate profile function to each of the effective image area and the scan direction change area.

9. The method of claim 8, wherein the scanning profile is a position profile, and the applying comprises applying a linear function to the effective image area and a function of second order or higher to the scan direction change area.

10. The method of claim 8, wherein the scanning profile is a velocity profile, and the applying comprises applying a constant function to the effective image area and a linear function to the scan direction change area.

11. The method of claim 10, wherein the velocity profile applies to the scan direction change area a linear function with a slope equal to or less than a predetermined slope.

12. The method of claim 8, wherein the scanning profile is an acceleration profile, and the applying comprises applying zero acceleration to the effective image area and a finite acceleration equal to or less than a predetermined acceleration to the scan direction change area.
